(19) United States
(12) Patent Application Publication
(10) Pub. No.: US 2011/0274964 A1
(43) Pub. Date: Nov. 10, 2011

(54) Battery Tabs and Method of Making the Same

(76) Inventor: Charles Tuffile, Dighton, MA (US)

(21) Appl. No.: 13/048,172

(22) Filed: Mar. 15, 2011

Related U.S. Application Data
(60) Provisional application No. 61/340,319, filed on Mar. 15, 2010.

(51) Int. Cl. H01M 2/30; H01M 10/02; H01M 6/42

(52) U.S. Cl. 429/156; 429/179

(57) ABSTRACT

A terminal for a Li-ion battery cell utilizes a bimetallic strip formed from the materials used as the Li-ion cell current collectors, such as copper and aluminum. The bimetallic strip is to be used as, at least one, of the Li-ion pouch cell terminals. At least one portion of the bimetallic strip has one of the metallic components removed by such means as chemical or electrochemical etching, mechanical milling, skiving, or grinding, the remaining component being connected to the collector and the other end of the strip serving as the terminal.

### BACKGROUND OF THE INVENTION

This application claims priority from Provisional U.S. Patent Application No. 61/340,319 filed Mar. 15, 2010.

The present invention relates to the field of battery packs and more particularly to the joining of battery tabs from battery cells to make battery packs. Battery packs are designed to deliver a particular voltage and current, greater than an individual cell, by connecting individual battery cells in series and/or parallel configurations. Battery cells connected in series produce an increase in the voltage, and those connected in parallel produce an increase in the current. Batteries are connected in series when the positive and negative terminals of the battery are electrically joined. When a positive terminal is joined to another positive terminal, and the negative terminal is joined to another to negative terminal, then the batteries are connected in parallel.

Joining of battery terminals requires an electrical path be produced between the cells and can be achieved via physical contact, welding, soldering, or other joining techniques. When both the positive and negative terminals are composed of the same metal, joining is relatively easy to produce robust connections. However, when the positive and negative battery terminals are each composed of different metals, joining is complicated due to issues of metal compatibility and corrosion.

Most of the commonly available battery types, including alkaline, NiCd, NiMH, and NiZn chemistries have positive and negative terminals with common metals. Li-ion battery terminals, however, typically utilize dissimilar metal terminals since they are connected internally to dissimilar metal current collectors, and the terminals are typically the same material as the current collector, or a compatible material with the current collector. Current collectors in Li-ion cells are typically copper and aluminum foils, which are connected to the terminals inside the battery case. The terminals extend out of the battery case where they can be connected.

Li-ion battery separators, which separate the anode and cathode and the current collectors, can only tolerate relatively low temperatures above which the separator melts. The low temperature tolerance of the separator limits the joining techniques that can be used to join the terminals to the current collectors and the terminals to other terminals. The terminal-to-current-collector joints are typically produced with ultrasonic welding, a solid state welding process that does not result in large excursions in temperature of the materials being joined. The joints between the terminals are produced with a number of techniques including mechanical fastening, ultrasonic welding, and laser welding. When joining the terminals close attention must be paid to the temperature rise in the terminals which can quickly conduct the heat into the cell and raise the separator temperature high enough to melt it.

The terminal materials, in Li-ion battery cells, are typically the same material as the current collectors such that there is no galvanic cell created between the terminals and current collector inside the battery case. If the terminal and current collector were dissimilar metals inside the battery they would galvanically corrode and electrically disconnect the current collector from the terminal inside the battery cell.

Dissimilar metal Li-ion battery terminals present issues in joining the battery terminals due to metal incompatibility which can lead to corrosion, increased resistance, and a lack of joint robustness.

If a joint between the current collector and terminal, or between terminals, were to fail due to metallurgical or corrosive events there exists a large potential for electrical arcing at the failure point. The electrical arcing can produce large temperature excursions which can conduct into the Li-ion cell and lead to melting of the separator and a thermal runaway event.

This invention provides a means of overcoming these issues for Li-ion pouch cells.

### SUMMARY OF THE PRESENT INVENTION

It is an object of the present invention to create more robust joints (welds), with significantly greater corrosion resistance than with the other technologies that are employed such as mechanical fastening and ultrasonic and laser welding. Mechanically fastened joints are prone to loosening of the joints over time and arcing between the terminals. Ultrasonic welding creates solid state welds of dissimilar metals, however, the incompatibility of the metals results in a less robust weld than if like-metals are joined. Ultrasonic welding like-metal joints produces a more robust weld than when dissimilar welds are produced. Laser welding, or other non-solid-state welding methods, produces second phases in the mixed-metal weld zone, which can dramatically reduce the robustness of the weld. The dissimilar metals joints created with mechanically fastened joints, ultrasonic, and laser welds have a high potential for galvanic corrosion. The like-metal joints created with bimetallic terminals in accordance with the present disclosure have no potential for galvanic corrosion.

These and other objects and advantages of the invention will become apparent from the following detailed description of the preferred embodiment of the invention.

### BRIEF DESCRIPTION OF THE DRAWINGS

A battery pack with the tabs of this disclosure is depicted in the accompanying drawings which form a portion of this disclosure and wherein:

FIG. 1 is a perspective view of a battery pack with four Li-ion pouch cells wherein each cell has one monolithic metal terminal and one bimetallic terminal.

FIG. 2 is an end elevational view, partially in phantom, of two cells of a Li-ion pouch cell battery pack showing the cells connected via bimetallic terminal joined to a monolithic metal terminal.

FIG. 3 is an end elevational view, partially in phantom, of another configuration of two cells of a Li-ion pouch cell battery pack showing the cells connected via bimetallic terminal joined to a monolithic metal terminal.

### DESCRIPTION OF THE PREFERRED EMBODIMENT

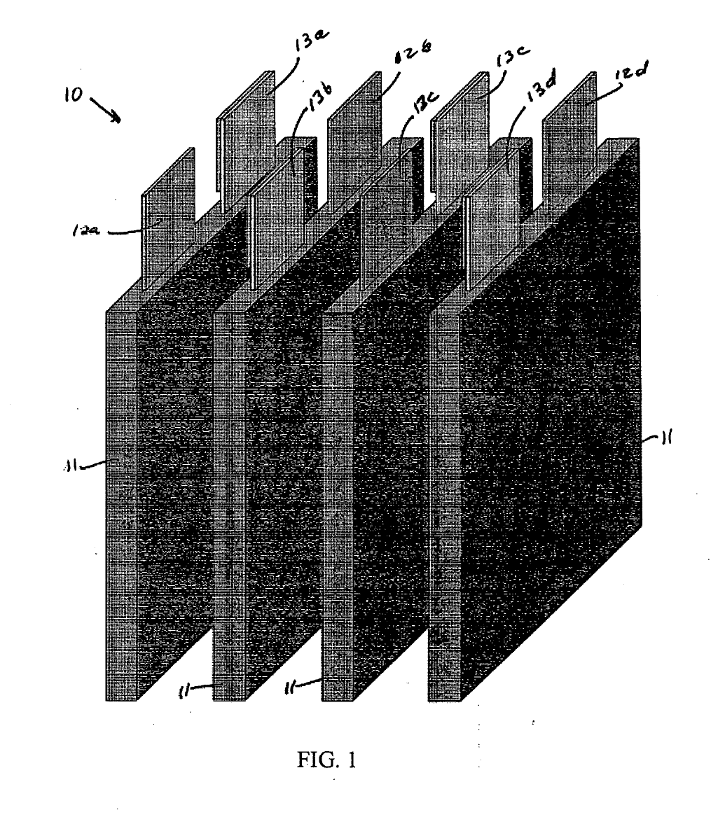

Referring to the FIGS. 1-3 for a clearer understanding of the invention, it may be seen that the preferred embodiment of the battery tab contemplates a bimetallic strip made up of the materials used as the Li-ion cell current collectors, such as copper C and aluminum Al. The bimetallic strip is to be used as, at least one, of the Li-ion pouch cell terminals. At least one edge of the bimetallic strip has one of the metallic components removed by such means as chemical or electrochemical etching, mechanical milling, skiving, or grinding. The bimetallic strip can be produced with a number of technologies including roll bonding, plating, explosion cladding, diffusion bonding, and the like.

Referring to FIG. 1, disclose a Battery pack 10 with four Li-ion pouch cells, 11a, b, c, and d. Each cell has one monolithic metal (such as copper) terminal 12a, b, c, or d, and one bimetallic terminal 13a, b, c, or d. The cells 11 are arranged in a series configuration such the bimetallic terminals 13 are adjacent to the monolithic metal terminals 12. The monolithic metal terminals 12 can be joined to the like-metal surface of the bimetallic terminal 13 to create a robust, corrosion-resistant joint.

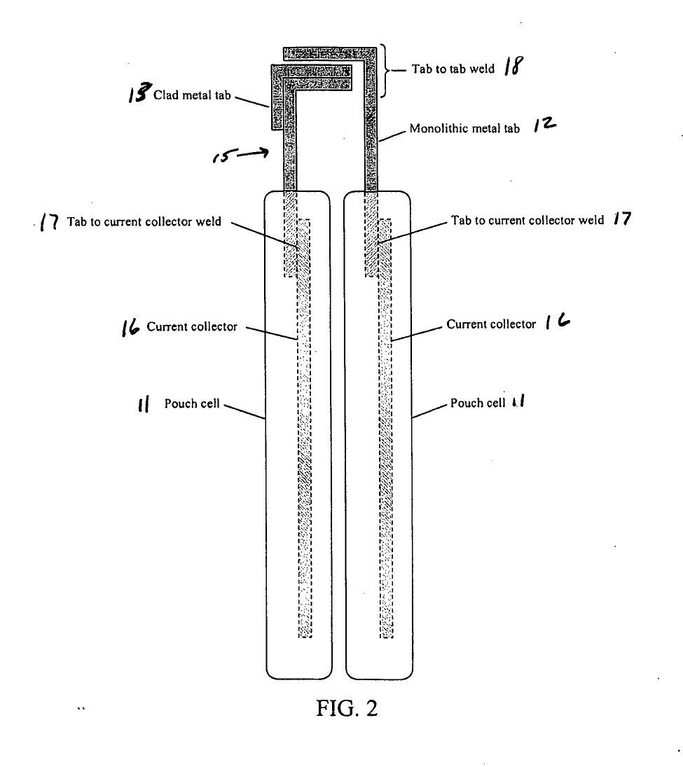

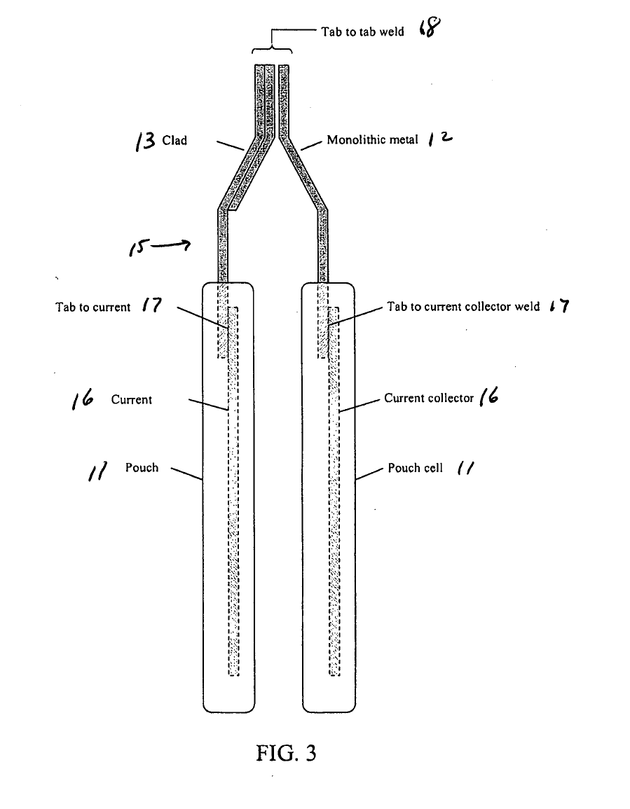

Referring to FIGS. 2 and 3 the bimetallic terminal 13 is formed of a bimetallic strip 15 that has had one metallic component etched away. This end of strip 15 is used to connect the current collector 16 internally of the cell 11 at 17. The current collector 16 is of the same metal as the etched end of the bimetallic strip 15, thus the other end of the bimetallic strip 15, which could retain its bimetallic structure or be chemically etched to leave only one metal, extends out of the pouch cell forming bimetallic terminal 13 and provides a means for joining to the monolithic terminals 12 in the battery pack 10 at 18. The like-metal components of the terminals 12 and 13 can be joined in a number of configurations, a couple of which are shown in FIGS. 2 & 3.

The like-metal joints between the current collector 16 and bimettalic strip 15, and between the two terminals 12 and 13, provide a location for creating robust joints via welding such as ultrasonic welding, laser welding, resistance welding, or similar methods. The like-metal joints are free of secondary phases, such as brittle intermetallic phases, which results in strong, highly conductive, joints since no insulative intermetallic compounds exists at the joint. Without secondary phases at the joint, the joint is more prone to surviving extended vibrations such as would be experienced in an automobile.

The like-metal joints between the current collector 16 and bimettalic strip 15, and between the two terminals 12 and 13 also provides a connection which for eliminating any potential for galvanic corrosion since like metals are joined. The joint is thus significantly more corrosion resistant than a dissimilar metal joint. If galvanic corrosion were to occur between the current collector and terminal, or between two terminals, the less noble of the two metals can be perforated by the corrosion.

It is to be understood that the form of the invention shown is a preferred embodiment thereof and that various changes and modifications may be made therein without departing from the spirit of the invention or scope as defined in the following claims.

What is claimed is:

1. In a battery pack having a plurality of cells to be connected, each cell including a pair of discrete internal current collectors of dissimilar metals, the improvement comprising at least one terminal in each cell comprising a bimetallic strip formed with a layer of each metal of said dissimilar metals, each bimetallic strip having one of said layers removed at a first end thereof, said first end being electrically connected to one of said pair of discrete current collectors having the same metal as said first end, said bimetallic strip extending from said cell with at least said other layer exposed to form a battery terminal for electrical connection of said battery cell; and, at least one other terminal formed of at least the same metal as said other discrete internal current collector of said pair of discrete internal current collectors and connected thereto at a first end of said at least one other terminal, with a second end of said at least one other terminal extending from said cell for electrical connection of said battery cell.

2. The improvement as defined in claim 1 wherein said dissimilar metals are copper and aluminum.

3. The improvement as defined in claim 2 wherein said bimetallic strip is a strip of clad aluminum and copper.

4. The improvement as defined in claim 2 wherein said bimetallic strip is a strip of roll bonded aluminum and copper.

5. The improvement as defined in claim 2 wherein said bimetallic strip is a strip of plated aluminum and copper.

6. The improvement as defined in claim 2 wherein sad bimetallic strip is a strip of diffusion bond aluminum and copper.

7. The improvement as defined in claim 2 wherein at least one other terminal is a strip of copper.

8. The improvement as defined in claim 7 wherein said at least one other terminal is connected to a copper side of said at least one terminal.

9. The improvement as defined in claim 8 wherein said at least one other terminal is connected to said at least one terminal at an ultrasonic weld joint.

10. The improvement as defined in claim 8 wherein said at least one other terminal is connected to said at least one terminal at a laser weld joint.

11. The improvement as defined in claim 8 wherein said at least one other terminal is connected to said at least one terminal at a resistance weld joint.

12. The improvement as defined in claim 1 wherein said at least one other terminal is connected to said at least one terminal without any secondary phases there between.

13. The improvement as defined in claim 1 wherein said plurality of cells are Lithium ion cells.
